(19) United States
(12) Patent Application Publication
(10) Pub. No.: US 2005/0233712 A1
(43) Pub. Date: Oct. 20, 2005

(54) Low-frequency signal correction circuit

(75) Inventors: Fred Michael Stefanik, Feeding Hills, MA (US); Bruce Thomas Herget, Wellington, FL (US)

Correspondence Address: OBLON, SPIVAK, MCCLELLAND, MAIER & NEUSTADT, P.C., 1940 DUKE STREET, ALEXANDRIA, VA, 22314, US

(73) Assignee: THALES BROADCAST & MULTIMEDIA, INC., Southwick, MA (US)

(21) Appl. No.: 10/825,298

(22) Filed: Apr. 16, 2004

(51) Int. Cl. H04B 1/04; H01Q 11/12; H04N 5/21

(52) U.S. Cl. 455/114.2; 455/119

(57) ABSTRACT

A correction circuit for reducing the amount of noise generated in an analog television transmission system. A correction circuit generates a signal with opposite phase and identical amplitude to a noise signal generated by a high power amplifier and this signal is modulated with an analog television signal to be transmitted. The introduction of the reference signal results in the cancellation of the noise signal generated by the high power voltage source and results in a television signal being transmitted with a reduced level of noise.

### CROSS-REFERENCE TO RELATED PATENT DOCUMENTS

This application contains subject matter related to that disclosed in U.S. patent application Ser. No. 10/076,327 filed on Feb. 19, 2002, the entire contents of which is incorporated herein by reference.

### BACKGROUND OF THE INVENTION

1. Field of the Invention

The present invention relates to a signal correction circuit applicable for use in an analog television transmitter circuit. The invention is applicable to correction circuits for suppressing signal by-products of a high voltage power supply (HVPS). The invention applies to systems that use smaller, cheaper, and more reliable power supplies primarily designed for digital applications in an analog television transmitter by eliminating these signals and resultantly reducing the unwanted noise associated with the HVPS.

2. Discussion of the Background

With the introduction of digital television (DTV) to the television broadcast industry, transmitter manufacturers have been able to reduce filtering requirements for transmitter power supplies without compromising DTV transmitter performance. In turn, this has allowed enhancements to transmitter reliability because these power supplies require less protection circuitry in the transmitter. Conventionally, these power supplies are used in the industry for DTV, but are not used in analog systems because they do not satisfy strict noise and spurious emission requirements for analog transmitter systems. As recognized by the present inventor, a significant portion of noise level of the DTV power supply results from an offending signal which is generated by the HVPS.

An HVPS, such as that disclosed in U.S. patent application Ser. No. 10/076,327, the entire contents of which is incorporated herein by reference, is typically, but not exclusively, applicable to digital television transmitters and CW (continuous wave) or pulsed RF amplifiers where a signal-to-noise ratio (SNR) is not as stringent as for analog transmitters. In such digital applications, the system design can demand less stringent filtering requirements of the HVPS, to develop a transmitter amplifier system that exploits the lower cost of the linear HVPS and eliminate the cost and complexity of either a shunt crowbar circuit or a switching power supply, which are conventionally believed to be necessary in conventional analog television transmitter power supplies. The purpose of the shunt crowbar circuit or switching power supply is to prevent damage to the inductive output tube (IOT) used in the high power final amplifier. A solid state based switch for the AC mains is used for its faster turnoff time, and a solid state switch using a Silicon Controlled Rectifier (SCR) device can interrupt the AC supply to a transformer connected thereto in approximately 9 milliseconds when excessive load current is detected. This type of device is conventionally believed to be required to appropriately limit the follow-on current, thereby protecting the IOT from damage.

The present inventor recognized that the simplified power supply configuration used in digital devices addresses the stored energy in the HVPS as well as the speed at which the AC line is opened so as to eliminate the need for the crowbar circuit. The power source includes a filter that maintains the performance of the transmitter while reducing the stored energy and/or limiting the discharge rate of the stored energy thereby creating a system that will protect the IOT from damage caused by an arc within the vacuum envelope.

The power supply described above also uses “standard” linear voltage power supply technology and thus relies on a solid state, electronic primary switch to facilitate the removal of the input AC mains' power faster than a typical electromechanical contactor, and an output filter on the power supply that has sufficiently low stored energy to avoid tube damage, but sufficient filtering to support a DTV signal. The DTV signal is easier to accommodate for this application in that it has a lower SNR ripple requirement from the HVPS and experiences much shorter duration, dynamic load changes than that required to support analog television. The filtered, linear HVPS is arranged in such a manner as to properly provide power to an IOT using DTV service while fully protecting the IOT from potential harm, without the use of either a protective shunt crowbar circuit, or a medium-to-high frequency switching regulator type power supply. The filter meets DTV performance requirements and protects an IOT in a manner that meets the IOT manufacturer's requirements.

As stated above, the simplified power source satisfies the noise requirements for the transmission of DTV signals, which have a lower HVPS SNR ripple requirement and experiences much shorter duration, dynamic load changes than analog television. However, as recognized by the present inventor, it is desirable to use the advantages of the simplified HVPS by using the configuration in an analog television transmitter.

FIGS. 1A and 1B illustrate the variation between the HVPS SNR specifications required for analog television 130 versus that required for DTV transmitters 110. As shown in FIG. 1B, a typical analog television transmitter requires that the noise ceiling be at least 52 dB (i.e., 52 dB down from the peak analog signal) for proper operation. Conversely, as shown in FIG. 1A, DTV transmitters are less strict in that they require the noise ceiling only be −27 dB in order to adequately transmit a DTV signal. Therefore, the filtering in the HVPS used for the DTV system is able to be greatly simplified.

A conventional HVPS typically generates a signal that is a multiple of the AC line frequency, and when introduced into the analog transmitter circuit, results in an excessive SNR that is over the specified threshold required for analog television transmitters. The signal is due to the line frequency of the AC used to provide power to the HVPS, and these signals will be centered at different frequencies when the HVPS is designed for use with AC power at different frequencies. Generally, the main signals will range from 40 Hz to 720 Hz, when considering the fundamental frequency and up to the 12^{th} harmonic of the fundamental because of various line, transformer, and rectifier configurations. The HVPS supplies power, and the inadvertent signal, to the IOT high power amplifier, thus causing the transmission signal that is input to the amplifier to be modulated with these signals. Therefore, the signal that is ultimately transmitted is the television signal modulated with the offending signal.

FIG. 2 is a block diagram of a conventional analog television exciter. The exciter modulates an intermediate frequency (IF) analog television signal (video and audio components) with a multiplied local oscillator (LO) frequency to output a signal at the UHF or VHF radio frequency (RF) level for transmission. The exciter also filters and amplifies the RF signal before it is output for further amplification.

More specifically, a LO 201 generates a signal which is output to a multiplier 202 that steps the signal up in frequency before being applied to the input of a mixer 203. In the mixer 203, the multiplied LO signal is mixed with a modulated video IF and sound IF signals and output as an RF signal at a UHF or VHF transmission frequency. The RF signal is then input to a band pass filter 204, which suppresses unwanted mix products or images, and then the RF signal is amplified by a pre-amplifier 205 before being output to the transmitter for further amplification and subsequent transmission. This configuration is the general configuration for an analog television exciter, but any suitable substitute configuration for the analog television exciter may be used.

### SUMMARY OF THE INVENTION

One aspect of the present invention is to address and resolve the above-identified and other limitations of background art devices. The present invention accomplishes this by providing a circuit and method for suppressing an undesired signal generated by the HVPS so as to make the HVPS suitable for use for analog television applications. As the offending signal contributes significantly to the SNR level of the analog television signal, the present invention substantially suppresses or entirely eliminates the offending signal so as to make the simplified HVPS suitable for use in an analog television transmission system.

This invention is particularly, but not exclusively, applicable to analog television transmitters where the acceptable level of signals and spurious generated by the power supply is more stringent than in DTV applications. In such applications, this system design can leverage the simplified design of the HVPS configured for DTV applications by significantly reducing the SNR of the final signal. Specifically, eliminating an offending signal at a predetermined frequency (e.g., 60 Hz, and its harmonics) generated by the HVPS increases the SNR of the final signal to a level that is acceptable for analog television applications.

One aspect of the present invention is that it suppresses coherent noise and spurious interference generated by the HVPS by modulating a noise cancellation signal with the television signal that is to be transmitted. Specifically, the cancellation signal has the exact amplitude and inverse phase of the offending signal. So when the modulated transmission signal and cancellation signal are input to the IOT high-power amplifier, the cancellation signal eliminates the effect of the signal that is introduced by the HVPS. The correction circuit is configured such that the amplitude and phase of a 60 Hz reference signal can be amplitude and phase adjusted before the signal is modulated with the audio and video television signals.

The adjustment of the phase and amplitude of the reference signal (which optionally contains harmonics if the offending signal also contains harmonics) is accomplished either manually or automatically to ensure that the resultant cancellation signal has a same amplitude and inverse phase of the offending signal (which may contain harmonics) generated by the HVPS. This cancellation of the offending signal that is generated by the HVPS allows the SNR of the final signal to be increased sufficiently so that this type of power supply can satisfactorily be used for an analog signal transmission application.

According to one aspect of the present invention, the correction circuit generates a signal with phase and amplitude adjusted sufficiently to cancel the offending signal generated by the HVPS. According to this aspect the cancellation signal is modulated with the RF signal before the signal is input to the IOT amplifier for amplification.

The present invention may also include a feedback mechanism that allows for accurate, dynamic adjustment of the phase and amplitude of the reference signal in the correction circuit. Specifically, feedback may be supplied from the output of the HVPS or a power tap from the output of the high power final amplifier. The feedback from these sources is representative of the offending signal and is used in a number of ways. Specifically, if the correction circuit is implemented using a digital signal processor (DSP), the DSP is configured to receive the feedback signal and automatically adjust the phase and amplitude of the reference signal. Alternatively, the feedback signals are routed to an external control device, which then processes the feedback signal and generates a control signal that is transmitted to the correction circuit to adjust the amplitude and phase settings for the correction circuit. The correction circuit is also capable of being adjusted manually.

### BRIEF DESCRIPTION OF THE DRAWINGS

A more complete appreciation of the present invention and many of the attendant advantages thereof will be readily obtained as the same becomes better understood by reference to the following detailed descriptions and accompanying drawings:

FIGS. 1A and 1B are block diagrams indicating a difference in specified SNR for digital transmission systems verses analog television transmitter systems;

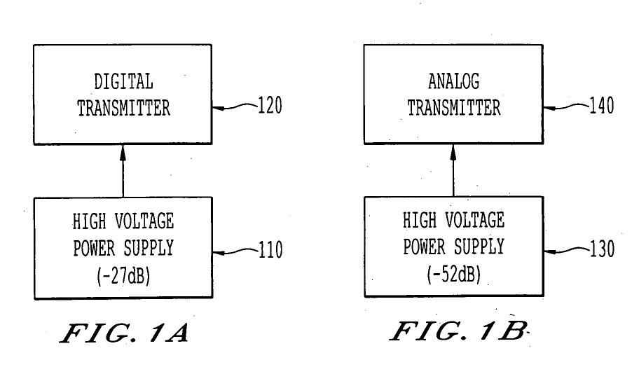

FIG. 2 is a block diagram of a conventional exciter circuit for an analog television transmitter;

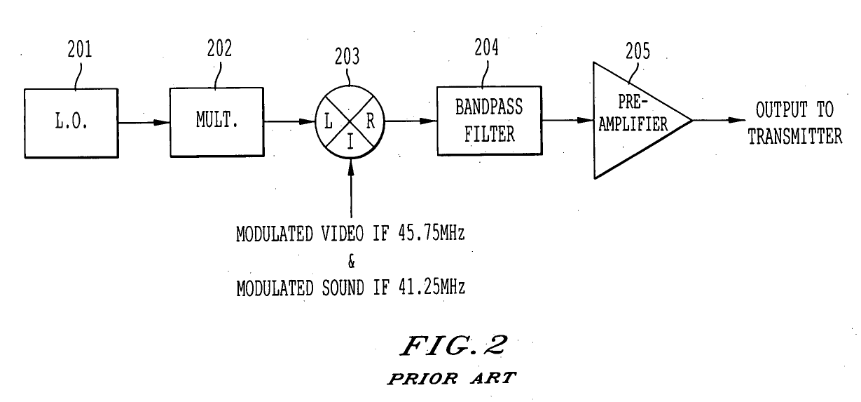

FIG. 3 is a block diagram showing a HVPS and an analog signal transmission system according to the present invention;

FIG. 4 is a block diagram of an analog television exciter circuit according to the present invention;

FIG. 5 is a block diagram of an analog television exciter system, analog RF transmission system and high voltage power supply according to the present invention;

FIG. 6 is a spectral output of a television signal after it has been modulated with the reference signal;

FIG. 7 is a block diagram of another analog television exciter circuit according to the present invention;

FIG. 8 is a block diagram of another variant of the analog television exciter circuit according to the present invention;

FIG. 9 is a block diagram of a correction circuit implemented with a digital signal processor (DSP) according to the present invention;

FIG. 10 is a diagram of the correction circuit and input/output port for receiving feedback signals and control signals according to the present invention; and

FIG. 11 is a block diagram of a computer device that may be used to control the correction circuit according to the present invention.

### DETAILED DESCRIPTION OF THE INVENTION

The following comments relate to the drawings, wherein like reference numerals designate identical or corresponding parts throughout the several views.

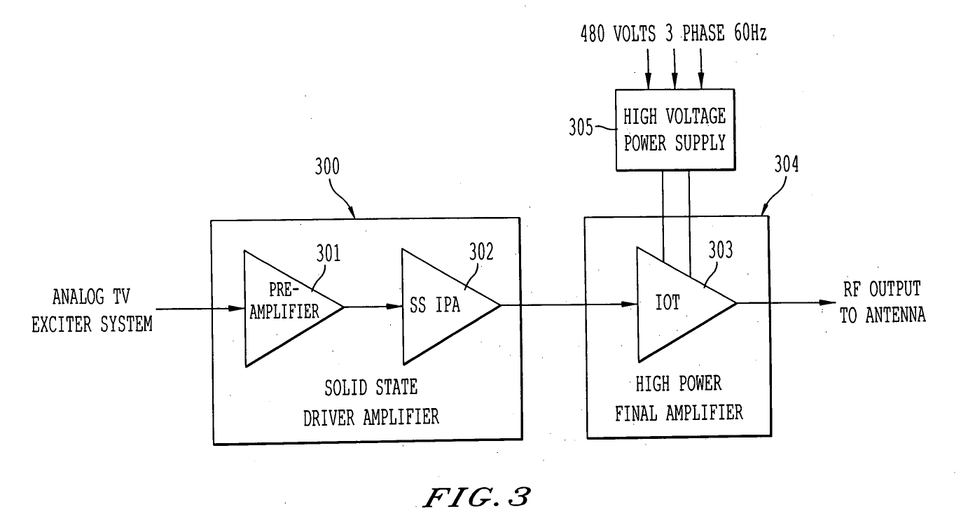

FIG. 3 is a block diagram of an exemplary embodiment of an RF transmitter to be used in conjunction with present invention. The output RF signal from an analog television exciter is applied to a solid state driver amplifier 300, which includes a preamplifier 301 and a solid state intermediate power amplifier (SS IPA) 302. The output signal from the solid state driver amplifier 300 is then applied to the IOT high power final amplifier 303, which amplifies the signal to a power level suitable for transmission via the television signal transmission antenna. The high power final amplifier 303 is provided with power from the HVPS 305, which receives 480 V, 3-phase power at 60 Hz and produces regulated DC to the IOT 303.

The HVPS is the simplified HVPS as described above (and as included in Thales' DCX Paragon transmitter product) which implements neither a protective shunt crowbar system, nor a medium-to-high frequency switching regulator system. The HVPS is also configured to have noise levels (which include spurious levels) suitable for transmission of DTV signals (e.g., −27 dB relative to the carrier). Because of the reduced signal to spur ratio needed to adequately transmit the DTV signal, the HVPS is designed to permit noise levels well in excess (25 dB) above that permitted for proper transmission of an analog television signal. A significant source of this noise is the line frequency based signal generated by the HVPS 305. (Throughout this specification, the term offending signal or hum signal will be used, although this term should be construed to cover the harmonics of the main frequency, and should be understood to be applicable to other common frequencies for standard power systems, such as 50 Hz). The offending signal is generated by the HVPS 305 and modulated with the output signal in the IOT final amplifier, and thus introduces an offending signal to the final output of the IOT high power final amplifier.

The present inventor recognized that it is the offending signal produced by the HVPS (which is specified for use with transmitters that transmit digital signals) that dominates the noise component of the transmitter system. In fact, the levels of the offending signal were so dominate that if they could be suppressed, the other noise components of the HVPS were sufficiently low that the HVPS would be suitable for use in analog transmitter systems. Thus, present inventor identified that the offending signal is the limiting factor in not being able to use the HVPS in analog transmission systems, and thus, once they suppressed this signal, the resulting SNR generated by the HVPS was adequate for use in analog television transmission systems. (Throughout this specification the term SNR is used, although it should be construed to cover not only white noise, but spurious emissions, such that SNR covers signal-to-spur ratios as well.)

To this end, in order to appropriately cancel, or adequately suppress, the offending signal produced by the HVPS, a method and apparatus according to the present invention modulates the analog television transmission signal with a reference signal, or cancellation signal, (which mimics the offending signal, and thus may contain harmonic components as well, typically up to the 12^{th} harmonic) before the signal is amplified by the IOT amplifier. The cancellation signal is amplitude and phase adjusted in order to have exact (or substantially the same) amplitude and opposite phase of the offending signal. Thus, the offending signal is canceled, or at least adequately suppressed, by the reference signal so that the power provided from the IOT is of sufficient quality that it meets the specifications for analog transmission.

As shown in FIG. 3, the simplified HVPS 305, which as described above and is designed to support digital transmission systems that can tolerate power supply spurs 27 dB down from the main power levels, introduces an offending signal at the 27 dB down (or more) level as an undesirable input to the high power final amplifier. As a result the offending signal is modulated with the output of the high power final amplifier resulting in excessive noise in the output analog television transmission signal. Although the offending signal is tolerable for DTV transmission system, it must be mitigated, or corrected for, in order for the simplified HVPS to be satisfactorily used for analog transmission operations.

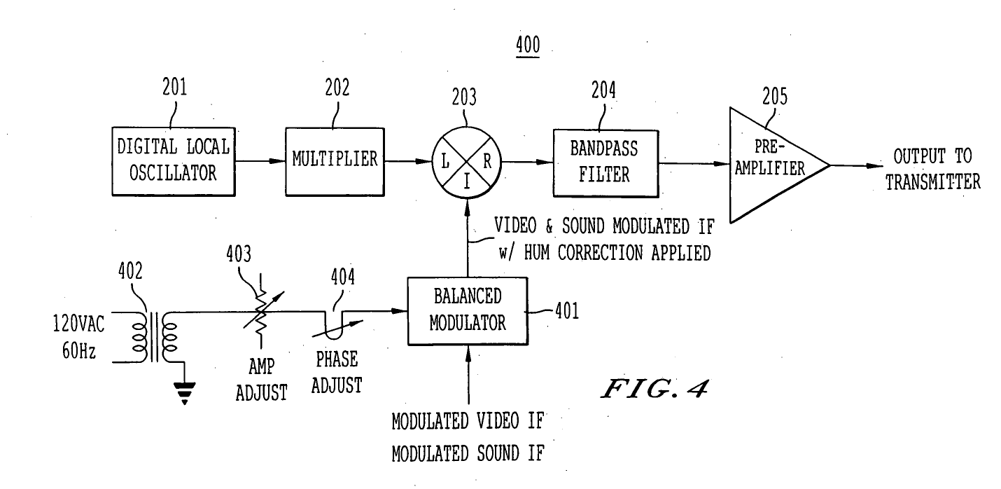

FIG. 4 is a block diagram of one exemplary embodiment of the correction circuit according to the present invention. The elements of the analog television exciter are the same as that described in FIG. 3. However, additional signal processing is performed on the visual and sound IF signals before they are input into the mixer 603 to be stepped up to the RF transmission frequency. Specifically, the cancellation signal is modulated with the visual and sound IF signals.

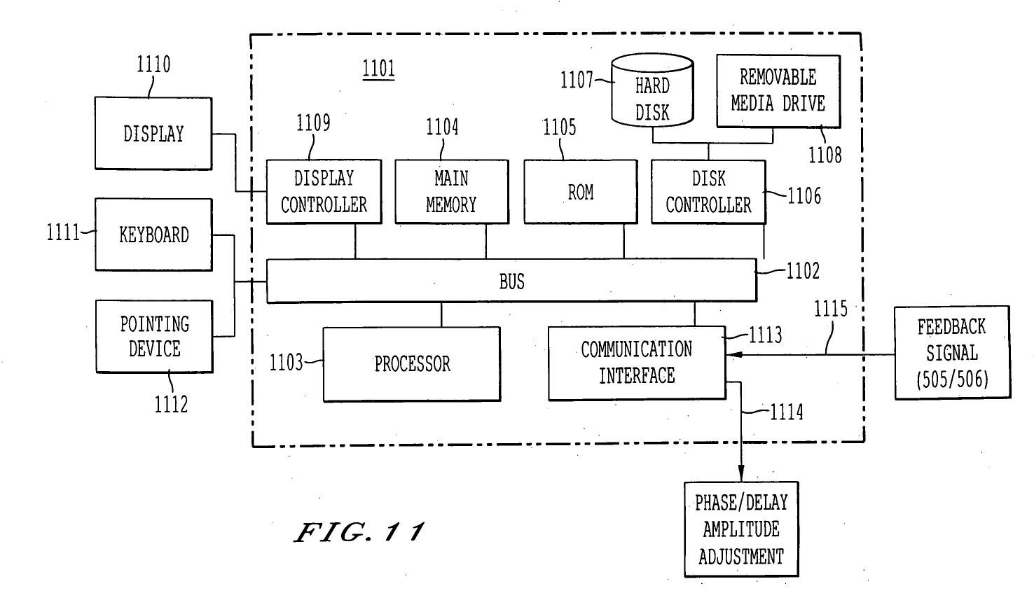

Before the modulated video and sound IF signals are input to the mixer 603, they are modulated with a cancellation signal with a substantially same amplitude and inverse phase of the offending signal introduced by the HVPS. The phase and amplitude of the signals are adjusted manually or automatically, via feedback signals, as discussed below. A transformer 402 is used to generate the reference signal which is amplitude adjusted with attenuator 403 and phase adjusted with phase shifter 404 to match the amplitude and phase the offending signal generated by the HVPS. Harmonics of the line frequency are produced by non-linearities of the transformer, and rectifier circuits. If further harmonic levels are required (to match those in the offending signal), there are a variety of common alternatives for creating those distortions. The result of the amplitude and phase adjustment is a cancellation signal suited to cancel the offending signals generated by the HVPS. The attenuator (or alternatively adjustable gain device) and phase adjuster 404 are individually controllable via a control signal. Alternatively, they are manually adjustable. In one embodiment, the main memory 1104 of the controller (FIG. 11) contains a look-up table of amplitude and phase adjustment amounts based on a level of noise monitored by a monitor circuit (not shown).

The amplitude and phase adjusted cancellation signal is modulated with the visual and sound IF signals in a balanced modulator 401, to produce a signal spectrum as seen in FIG. 4. The balanced modulator 401 is used to perform the modulation of the cancellation signal and the television signal, but other suitable substitutes may be used to perform this modulation. The output of the balanced modulator is then input to a mixer 203 with the multiplied L.O. signal to generate an RF signal. The RF signal is then input to a band-pass filter 204 and a preamplifier 205, before being output to the RF transmitter. The signal passed onto the RF amplifier contains the visual and sound television signals as well as a cancellation signal. This cancellation signal will mitigate the effects of the offending signal introduced by the HVPS, which is consequently modulated with the output signal in the IOT high power final amplifier. Therefore, the offending signal generated by the HVPS will be canceled with a signal of opposite phase and same amplitude and the effects of the excess offending signal generated by the simplified HVPS is eliminated in the final signal. Therefore, the excess noise attributed to the offending signal is mitigated, causing the final output signal to have a noise level which is significantly reduced so as to meet the specifications for transmission of an analog television signal.

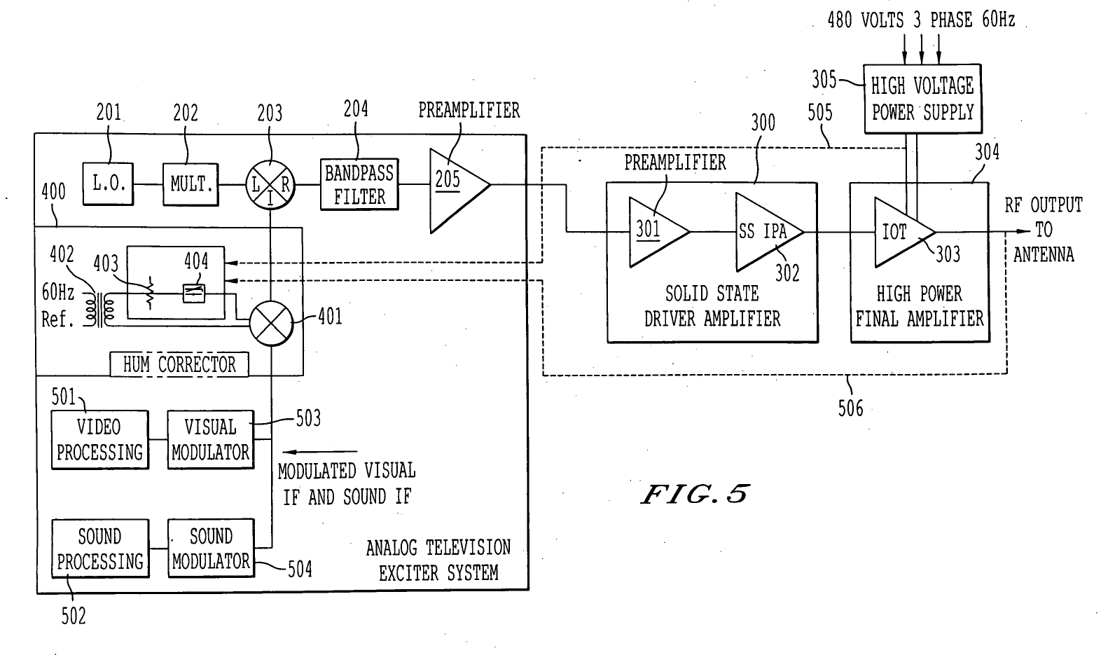

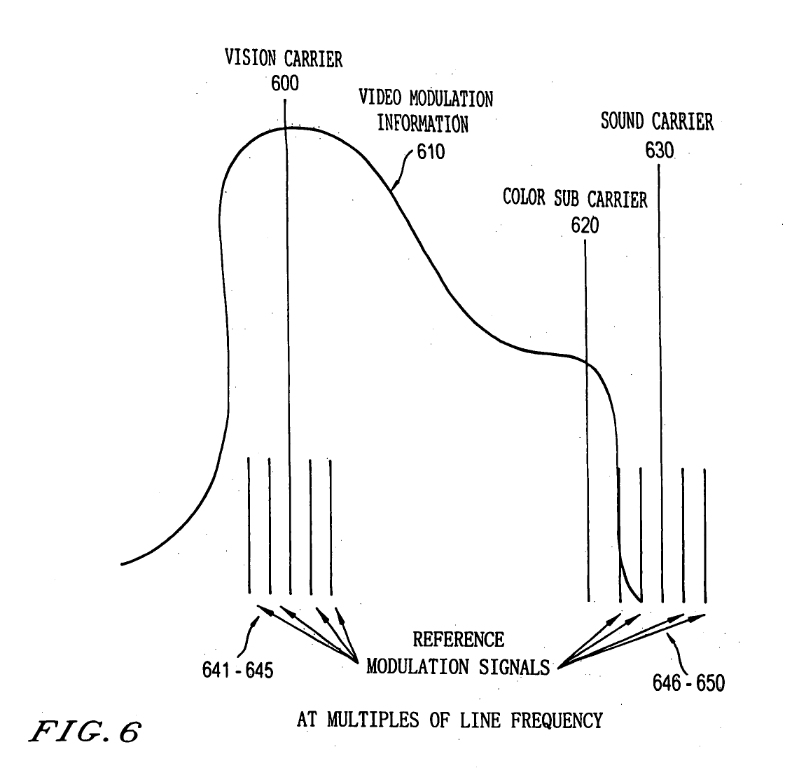

Prior to discussing the alternative circuit of FIG. 5, FIG. 6 is described to illustrate the spectral output of the modulated video and sound IF signals after modulation with the reference signal. The spectral output includes the typical components of an analog television signal such as a vision carrier 600, video modulation information 610, a color subcarrier 620, and a sound carrier 630. In addition to these signal components, the signal (prior to cancellation) also includes the offending signal, which manifests itself at line frequency and multiples of line frequency 641-650. Moreover, the HVPS produces unwanted spurious signals at multiples of line frequency, centered around the vision carrier and sound carrier. The spurious signals are centered about the vision carrier 600 and sound carrier 630 because the present inventor recognized that these line frequency harmonics are modulated onto the transmitted signal at the amplification stage. In order to offset these unwanted signals the cancellation circuit of FIG. 4 purposefully produces its own “noise” or “spurs” and modulates them onto the video IF and audio IF. While it is not customary to inject a noise signal into a desired signal, the present inventor recognized that by purposefully introducing a well-regulated noise signal upstream (in reference to signal flow) of an actual noise source, it is possible to offset the degradation in system performance caused by the actual noise source.

FIG. 5 is a system level diagram that includes a correction circuit and feedback control for using a HVPS (designed for digital systems) in an analog television transmitter system. The transmitter system includes an analog television exciter such as that described in FIG. 4, a SS driver amplifier 300, high power final amplifier 304 and a HVPS 305 the provides power to the IOT 303 of the high power final amplifier 304. The analog television exciter optionally performs video processing 501 and sound processing 502 on the video and audio signals respectively prior to passing the video component through a visual modulator 503 to produce a video IF, and passing the audio component through a sound modulator 504 to produce an audio IF. These modulated visual and sound intermediate frequency (IF) signals are then modulated with the input from the correction circuit that includes the transformer 402, attenuator 403 and phase adjuster 404. (As an alternative, a signal generation circuit may be used to create the correction signal.) As shown, control inputs are received from a power tap of the RF signal that is output to the antenna. This RF output is an effective measure as it contains the undesired signal. Although not shown, the power tap includes an adjustable attenuator so that the level of the signal provided to the correction circuit is within the dynamic range of the processor used by the correction circuit. In addition to, or as a substitute for the RF output power tap, a tap of the HVPS 305 DC power may be used to control the amplitude, phase, and spectral make-up needed for the correction signal.

The output of the corrector is modulated with the video IF and audio IF signals by way of balanced modulator 401. The modulated output of the modulator 401 is then applied to the mixer 203, which (as described in reference to FIG. 4) mixes the video and sound modulated IF (with the correction signal applied) with the output of the LO 201 after being multiplied by the multiplier 202. The output of the mixer 203 is the video and sound modulated RF signal (with the correction signal applied). The center frequency of the modulated RF signal is at an appropriate UHF or VHF RF frequency for transmission. The UHF or VHF RF signal is then passed to the RF transmission system to be filtered 204, pre-amplified 205 and then finally amplified and transmitted over-the-air via an antenna, suitable for analog signal transmission. In the RF transmission portion of the circuit the high power final amplifier 303, which is an IOT device, is supplied with 480 V of power from the HVPS 305 to provide power for the transmission of the RF signal.

As mentioned above, in order to correct the offending signal introduced by the HVPS 305, a correction signal with a substantially same amplitude and inverse phase of the offending signal is modulated with the analog transmission signal before it is amplified by the RF transmission system. Therefore, when the offending signal is modulated with the audio and visual RF signal in the IOT final amplifier, the cancellation signal exactly offsets the offending signal. The result of the cancellation of the offending signal is that a large portion of the excess noise generated by the HVPS is mitigated and the simplified HVPS is suitable for use in an analog television transmission system.

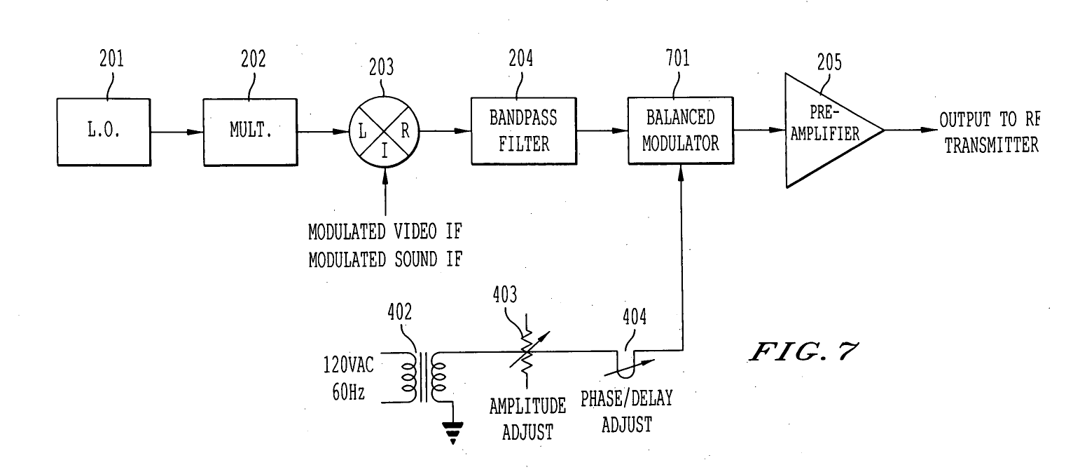

FIG. 7 is a block diagram of another embodiment of the invention. In this embodiment the analog television exciter is as disclosed in FIG. 5, with the exception of a balanced modulator 701 placed between the output of the band pass filter 204 and the input of the preamplifier 205. The balanced modulator 701 modulates the filtered RF transmission signal with the cancellation signal. This embodiment differs from the configuration described in FIG. 6, in that the cancellation signal is introduced to the analog television signal after it has been stepped up to the UHF or VHF transmission frequency and filtered by the band pass filter 204. The transformer 402 is used to generate a reference signal which is amplitude adjusted 403 and phase adjusted 404 to match the amplitude and phase the offending signal generated by the HVPS. This 60 Hz signal is then modulated with the RF signal passed from the band pass filter 204. Thus, the output of the band pass filter 704 contains the audio and visual components of the signal, along with the cancellation signal, as illustrated in FIG. 4.

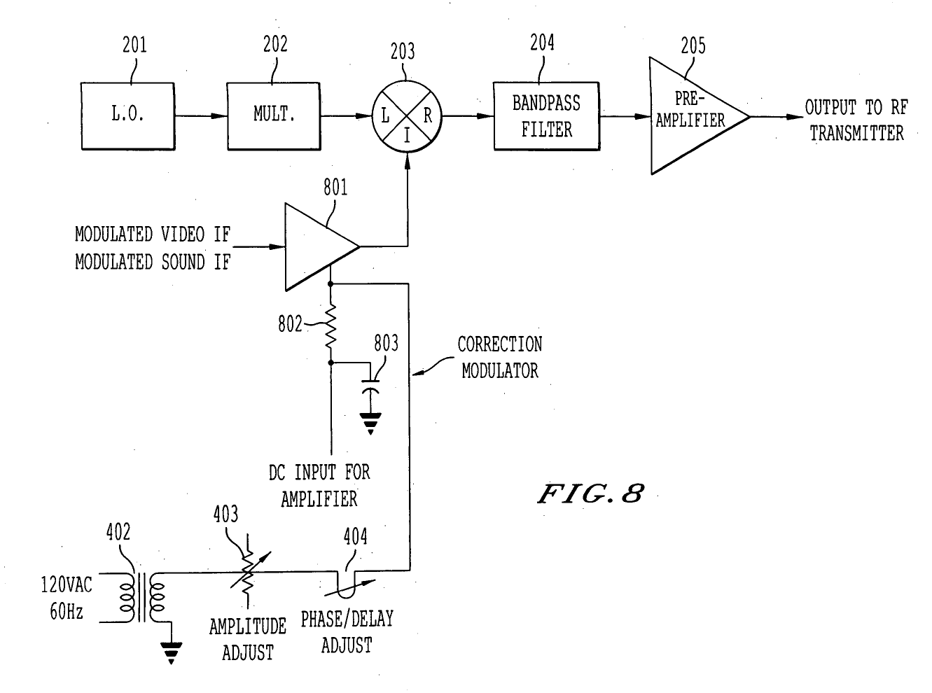

FIG. 8 is yet another embodiment of the correction circuit. In this embodiment the elements of the analog television exciter are the same as that describe in FIG. 5, however, the visual and sound IF signals are modulated with a cancellation signal before being mixed with the multiplied LO frequency. Also, instead of using a balanced modulator to modulate the cancellation signal with the analog television signal a high-level modulated amplifier 801 is used. In this approach the correction signal is modulated onto the IF output by modulating the voltage supplied to the amplifier 801. A transformer 402 is used to generate a reference signal which is amplitude adjusted 403 and phase adjusted 404 to match the amplitude and phase the offending signal generated by the HVPS. The amplitude and phase adjusted cancellation signal is then added with the DC power input, to a high-level modulated amplifier. Modulated visual and sound IF signals are input to the high-level modulated amplifier, and modulated with the reference signal to produce a signal spectrum similar to that shown in FIG. 6. This signal is then mixed with the multiplied LO signal to generate an RF signal at a UHF or VHF frequency that is input through a band-pass filter 204 and a preamplifier 205, before being output to the RF transmitter. As discussed in relation to other embodiments of the present invention, the signal passed to the RF amplifier contains a correction signal that suppresses the effects of the offending signal introduced by the HVPS in the high power final amplifier.

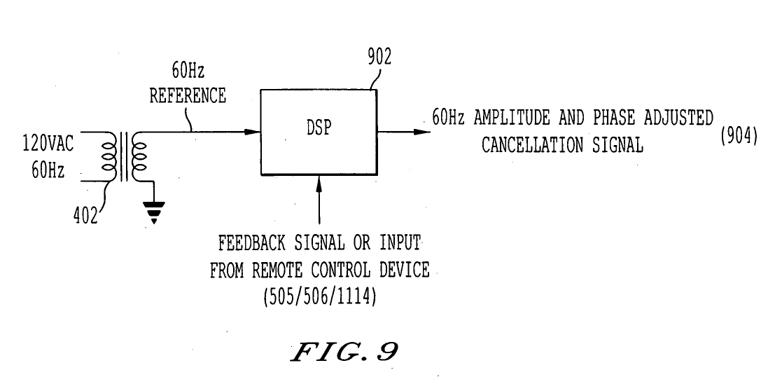

FIG. 9 is a block diagram of another embodiment of the present invention which uses a digital signal processor (DSP) 902 to perform the amplitude and phase adjustment operations of the 60 Hz reference signal to generate the appropriate cancellation signal. A transformer 402 generates a reference signal which is input to the DSP for amplitude and phase adjustment. Alternatively, a signal generator circuit may be used to produce the reference signal. The DSP 902 then outputs the amplitude and phase adjusted cancellation signal of inverse phase and substantially same amplitude of the offending signal generated by the HVPS. The cancellation signal is then modulated with the analog television signal as described in any of the above embodiments before being output to the RF amplification stage for transmission. As such, the digital signal processor 902 is able to replace the amplitude and phase adjustment devices as described in the previous embodiments of the present invention. The amplitude and phase settings may be manually adjusted or automatically adjusted by way of feedback, as described below.

Any of the embodiments may be adapted to use one or more feedback signals from either the output of the HVPS 505, or the IOT high power final amplifier 506 to dynamically adjust the amplitude and phase adjustment (or even spectral make-up, e.g., number of harmonics) of the reference signal. The feedback signal from the output of the HVPS 505 reflects the offending signal in its entirety before any correction whatsoever. Alternatively, the feedback from the output of the output of the IOT high-power amplifier would reflect the resultant signal after the offending signal was corrected and would likely be used for correction of the cancellation signal.

The feedback from either source can be fed directly to the DSP 902 used to correct the amplitude and the phase of the reference signal, thus allowing the DSP 902 to process the feedback signals and implement accurate phase and amplitude adjustment values. Specifically, the DSP 902 could be configured to receive feedback from either the output of the HVPS 505 or feedback from the output of the IOT high power final amplifier 506 and perform calculations (or level/angle matching operations) to properly adjust the amplitude and phase of the cancellation signal to cancel the offending signal generated by the HVPS. Thus, real time adjustments are made to the reference signal to increase accuracy of the cancellation signal, and eliminate the need for manual adjustment of the amplitude and phase shifting mechanisms.

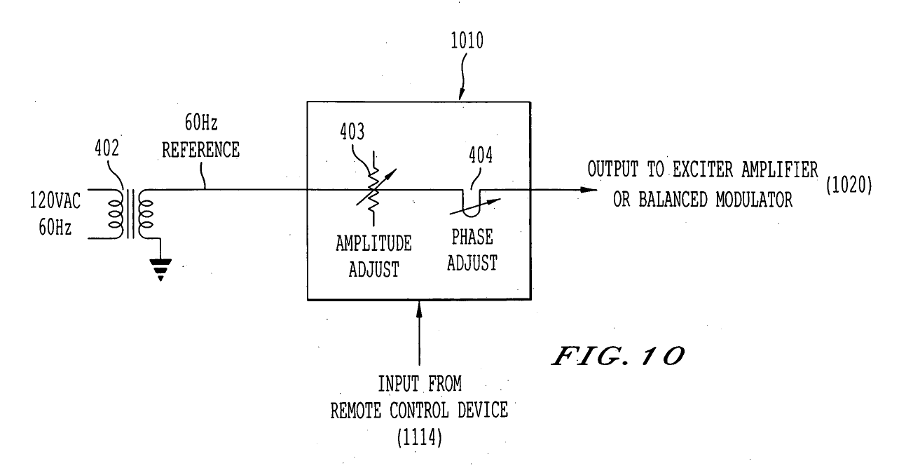

FIG. 10 is like the device of FIG. 9, although includes a remote control device 1114, which need not be located at the transmitter. Moreover, the feedback mechanism provides a signal to the remote control device 1114, which in turn produces control signals for adjusting the amplitude and phase of adjusters 403 and 404 in signal adjustment mechanism 1010. For example, the signal adjustment mechanism 1010 may include a network port that is configured to receive remote control signals over the Internet or via wireless communications, for example.

Another embodiment of the feedback mechanism, as well as the controller used for the correction circuit, includes a processor, or computer device 1101, with the ability to remotely control the amplitude and phase adjustment devices. Specifically, the feedback signals from the output of the HVPS or the IOT amplifier would be fed back to a processing device via an input port 1115, such as that described in relation to FIG. 11. Based on the received feedback signals, the processing device generates correction signals 1114 that could then be transmitted to the mechanism controlling the amplitude and phase adjustments of the reference signal. The mechanism receiving the control signal can either be the DSP 902 chip as discussed above, or another suitable mechanism configured to adjust the amplitude and phase settings of the devices controlling the reference signal. Based on the received control signal the amplitude and phase adjustment mechanisms would then adjust themselves to condition the reference signal to the appropriate amplitude and phase to cancel the offending signal.

FIG. 11 is a block diagram of a layout of the computer device that could be configured to receive the feedback from the high voltage power supply 505 and/or the output of the feedback from the high power final amplifier 506 and process the feedback signals in order to actively adjust the amplitude and phase in the correction circuit. As discussed above, the feedback signals from the two sources may reflect different properties relating to the offending signal. Specifically, the feedback 505 from the HVPS would show the offending signal in its original form, whereas the feedback signal originating from the output of the IOT amplifier would reflect the offending signal after it has been modulated with the television signal. In either case, when the computer device receives the feedback it determines the amplitude and phase of the offending signal generated by the high voltage power amplifier, or an error value of a currently supplied cancellation signal (in the case of the feedback from the output of the IOT final amplifier). Then, based on the determination, an output a control signal is transmitted to the correction circuit so that the correction circuit properly adjusts the amplitude and phase of the reference signal to cancel the offending signal generated by the HVPS to the high power final amplifier as seen at the output of this amplifier. The phase and amplitude could be corrected simultaneously or only the amplitude, and only the phase could be adjusted as needed.

FIG. 11 illustrates a computer system 1101 with which the remote control device of present invention may be implemented. The computer system 1101 includes a bus 1102 or other communication mechanism for communicating information, and a processor 1103 coupled with the bus 1102 for processing the information. The computer system 1101 also includes a main memory 1104, such as a random access memory (RAM) or other dynamic storage device (e.g., dynamic RAM (DRAM), static RAM (SRAM), and synchronous DRAM (SDRAM)), coupled to the bus 1102 for storing information and instructions to be executed by processor 1103. In addition, the main memory 1104 may be used for storing temporary variables or other intermediate information during the execution of instructions by the processor 1103. The computer system 1101 further includes a read only memory (ROM) 1105 or other static storage device (e.g., programmable ROM (PROM), erasable PROM (EPROM), and electrically erasable PROM (EEPROM)) coupled to the bus 1102 for storing static information and instructions for the processor 1103.

The computer system 1101 also includes a disk controller 1106 coupled to the bus 1102 to control one or more storage devices for storing information and instructions, such as a magnetic hard disk 1107, and a removable media drive 1108 (e.g., floppy disk drive, read-only compact disc drive, read/write compact disc drive, compact disc jukebox, tape drive, and removable magneto-optical drive). The storage devices may be added to the computer system 1101 using an appropriate device interface (e.g., small computer system interface (SCSI), integrated device electronics (IDE), enhanced-IDE (E-IDE), direct memory access (DMA), or ultra-DMA).

The computer system 1101 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1101 may also include a display controller 1109 coupled to the bus 1102 to control a display 1110, such as a cathode ray tube (CRT), for displaying information to a computer user. The computer system includes input devices, such as a keyboard 1111 and a pointing device 1112, for interacting with a computer user and providing information to the processor 1103. The pointing device 1112, for example, may be a mouse, a trackball, or a pointing stick for communicating direction information and command selections to the processor 1103 and for controlling cursor movement on the display 1110. In addition, a printer may provide printed listings of data stored and/or generated by the computer system 1101.

The computer system 1101 performs a portion or all of the processing steps of the invention in response to the processor 1103 executing one or more sequences of one or more instructions contained in a memory, such as the main memory 1104. Such instructions may be read into the main memory 1104 from another computer readable medium, such as a hard disk 1107 or a removable media drive 1108. One or more processors in a multi-processing arrangement may also be employed to execute the sequences of instructions contained in main memory 1104. In alternative embodiments, hard-wired circuitry may be used in place of or in combination with software instructions. Thus, embodiments are not limited to any specific combination of hardware circuitry and software.

As stated above, the computer system 1101 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1101, for driving a device or devices for implementing the invention, and for enabling the computer system 1101 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1103 for execution. A computer readable medium may take many forms, including but not limited to, non-volatile media, volatile media, and transmission media. Non-volatile media includes, for example, optical, magnetic disks, and magneto-optical disks, such as the hard disk 1107 or the removable media drive 1108. Volatile media includes dynamic memory, such as the main memory 1104. Transmission media includes coaxial cables, copper wire and fiber optics, including the wires that make up the bus 1102. Transmission media also may also take the form of acoustic or light waves, such as those generated during radio wave and infrared data communications.

Various forms of computer readable media may be involved in carrying out one or more sequences of one or more instructions to processor 1103 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1101 may receive the data on the telephone line and use an infrared transmitter to convert the data to an infrared signal. An infrared detector coupled to the bus 1102 can receive the data carried in the infrared signal and place the data on the bus 1102. The bus 1102 carries the data to the main memory 1104, from which the processor 1103 retrieves and executes the instructions. The instructions received by the main memory 1104 may optionally be stored on storage device 1107 or 1108 either before or after execution by processor 1103.

The computer system 1101 also includes a communication interface 1113 coupled to the bus 1102. The communication interface 1113 provides a two-way data communication coupling to a network link 1114 that is connected to, for example, a local area network (LAN) 1115, or to another communications network 1116 such as the Internet. For example, the communication interface 113 may be a network interface card to attach to any packet switched LAN. As another example, the communication interface 1113 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1113 sends and receives electrical, electromagnetic or optical signals that carry digital data streams representing various types of information.

The network link 1114 typically provides data communication through one or more networks to other data devices. For example, the network link 1114 may provide a connection to another computer through a local network 1115 (e.g., a LAN) or through equipment operated by a service provider, which provides communication services through a communications network 1116. The local network 1114 and the communications network 1116 use, for example, electrical, electromagnetic, or optical signals that carry digital data streams, and the associated physical layer (e.g., CAT 5 cable, coaxial cable, optical fiber, etc). The signals through the various networks and the signals on the network link 1114 and through the communication interface 1113, which carry the digital data to and from the computer system 1101 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1101 can transmit and receive data, including program code, through the network(s) 1115 and 1116, the network link 1114 and the communication interface 1113. Moreover, the network link 1114 may provide a connection through a LAN 1115 to a mobile device 1117 such as a personal digital assistant (PDA) laptop computer, or cellular telephone.

Obviously, numerous modifications and variations of the present invention are possible in light of the above teachings. It is therefore to be understood that within the scope of the appended claims, the invention may be practiced otherwise than as specifically described herein.

1. A cancellation circuit for canceling spurious signals generated by a high voltage power supply specified for use with a digital television transmitter system, but used to supply power to a high power amplifier in an analog television transmission system that has more strict spurious requirements than the digital television transmitter system, comprising:
a signal source configured to generate a reference signal having a predetermined frequency, said predetermined frequency being a multiple of line frequency of an AC power source that provides power to said high voltage power supply;
an amplitude adjustment mechanism configured to adjust an amplitude of said reference signal so as to match that of said spurious signal;
a phase adjustment mechanism configured to adjust a phase of said reference signal so as to be about 180 degrees out of phase with said spurious signal; and
a modulator configured to modulate said reference signal with an analog television signal after said reference signal is amplitude and phase adjusted by said amplitude adjustment mechanism and phase adjustment mechanism respectively, an output of said modulator being a composite signal, wherein
said composite signal is combined with said spurious signal prior to being transmitted so as to suppress said spurious signal to within said spurious requirements for said analog television transmission system.

2. The cancellation circuit Of claim 1,
wherein said signal source includes a transformer.

3. The cancellation circuit of claim 1,
wherein said composite output signal includes an audio signal, a video signal, and said reference signal after being amplitude and phase adjusted.

4. The cancellation circuit of claim 1, further comprising:
a mixer configured to mix said composite signal with a L.O. signal and output said composite signal at an RF transmission frequency before being combined with said spurious signal.

5. The cancellation circuit of claim 1,
wherein said amplitude adjustment mechanism and said phase adjustment mechanism are controlled based on a feedback signal, said feedback signal originating from an output of at least one of said high voltage power supply and said high power amplifier.

6. The cancellation circuit of claim 1,
wherein said amplitude adjustment mechanism and said phase adjustment mechanism are implemented in a digital signal processor.

7. The cancellation circuit of claim 1, further comprising:
a local oscillator and a multiplier configured to generate a L.O. signal;
a mixer configured to mix said composite signal output from said modulator and said L.O. signal, said mixer outputting said composite signal at an RF frequency, wherein said modulator is a balanced modulator; and
an amplifier configured to amplify said composite RF signal before said composite RF signal is combined with said spurious signal.

8. The cancellation circuit of claim 1, further comprising:
a local oscillator and a multiplier configured to generate an L.O. signal;
a mixer configured to mix said analog television signal and said L.O. signal, said mixer outputting said analog television signal at an RF frequency;
said modulator configured to modulate said analog television RF signal and said amplitude and phase adjusted reference signal, said modulator outputting said composite signal at an RF frequency, wherein said modulator is a balanced modulator;
an amplifier configured to amplify said filtered composite RF signal before said filtered composite RF signal is combined with said spurious signal.

9. The cancellation circuit of claim 1, further comprising:
a local oscillator and a multiplier configured to generate an L.O. signal;
a mixer configured to mix said composite signal output from said modulator and said L.O. signal, said mixer outputting said composite signal at an RF frequency, wherein said modulator is a modulated amplifier; and
an amplifier configured to amplify said composite RF signal before said composite RF signal is combined with said spurious signal.

10. A cancellation circuit for canceling a spurious signal generated by a high voltage power supply specified for use with a digital television transmitter system, but used to supply power to a high power amplifier in an analog television transmission system that has more strict spurious requirements than the digital television transmitter system, comprising:
means for generating a reference signal having a predetermined frequency, said predetermined frequency being a multiple of line frequency of an AC power source that provides power to said high voltage power supply;
means for adjusting an amplitude of said reference signal so as to match that of said spurious signal;
means for adjusting a phase of said reference signal so as to be about 180 degrees out of phase with said spurious signal; and
means for modulating said reference signal with an analog television signal after said reference signal is amplitude adjusted by said means for adjusting an amplitude and phase adjusted by said means for adjusting a phase, an output of said means for modulating being a composite output signal, wherein
said composite output signal is combined with said spurious signal prior to being transmitted so as to suppress said spurious signal to within said spurious requirements for said analog television transmission system.

11. An amplifier system that includes a cancellation circuit for canceling a spurious signal generated by a high voltage power supply specified for use with a digital television transmitter system, but used to supply power to a high power amplifier in an analog television transmission system that has more strict spurious requirements than the digital television transmitter system, said amplifier system comprising:
the cancellation circuit including
a signal source configured to generate a reference signal having a predetermined frequency, said predetermined frequency being a multiple of line frequency of an AC power source that provides power to said high voltage power supply,
an amplitude adjustment mechanism configured to adjust an amplitude of said reference signal so as to match that of said spurious signal,
a phase adjustment mechanism configured to adjust a phase of said reference signal so as to be about 180 degrees out of phase with said spurious signal, and
a modulator configured to modulate said reference signal with an analog television signal after said reference signal is amplitude and phase adjusted by said amplitude adjustment mechanism and phase adjustment mechanism respectively, an output of said modulator being a composite signal, wherein said composite signal is combined with said spurious signal prior to being transmitted so as to suppress said spurious signal to within said spurious requirements for said analog television transmission system;
a local oscillator and a multiplier configured to generate a L.O. signal;
a mixer configured to mix said composite signal output from said modulator and said L.O. signal, said mixer outputting said composite signal at an RF frequency, wherein said modulator is a balanced modulator; and
an amplifier configured to amplify said composite RF signal before said composite RF signal is combined with said spurious signal.

12. An amplifier system that includes a cancellation circuit for canceling a spurious signal generated by a high voltage power supply specified for use with a digital television transmitter system, but used to supply power to a high power amplifier in an analog television transmission system that has more strict spurious requirements than the digital television transmitter system, said amplifier system comprising:
the cancellation circuit including
a signal source configured to generate a reference signal having a predetermined frequency, said predetermined frequency being a multiple of line frequency of an AC power source that provides power to said high voltage power supply,
an amplitude adjustment mechanism configured to adjust an amplitude of said reference signal so as to match that of said spurious signal,
a phase adjustment mechanism configured to adjust a phase of said reference signal so as to be about 180 degrees out of phase with said spurious signal, and
a modulator configured to modulate said reference signal with an analog television signal after said reference signal is amplitude and phase adjusted by said amplitude adjustment mechanism and phase adjustment mechanism respectively, an output of said modulator being a composite signal, wherein said composite signal is combined with said spurious signal prior to being transmitted so as to suppress said spurious signal to within said spurious requirements for said analog television transmission system;
a local oscillator and a multiplier configured to generate an L.O. signal;
a mixer configured to mix said analog television signal and said L.O. signal, said mixer outputting said analog television signal at an RF frequency;
said modulator configured to modulate said analog television RF signal and said amplitude and phase adjusted reference signal, said modulator outputting said composite signal at an RF frequency, wherein said modulator is a balanced modulator;
an amplifier configured to amplify said filtered composite RF signal before said filtered composite RF signal is combined with said spurious signal.

13. An amplifier system that includes a cancellation circuit for canceling a spurious signal generated by a high voltage power supply specified for use with a digital television transmitter system, but used to supply power to a high power amplifier in an analog television transmission system that has more strict spurious requirements than the digital television transmitter system, said amplifier system comprising:
the cancellation circuit including
a signal source configured to generate a reference signal having a predetermined frequency, said predetermined frequency being a multiple of line frequency of an AC power source that provides power to said high voltage power supply,
an amplitude adjustment mechanism configured to adjust an amplitude of said reference signal so as to match that of said spurious signal,
a phase adjustment mechanism configured to adjust a phase of said reference signal so as to be about 180 degrees out of phase with said spurious signal, and
a modulator configured to modulate said reference signal with an analog television signal after said reference signal is amplitude and phase adjusted by said amplitude adjustment mechanism and phase adjustment mechanism respectively, an output of said modulator being a composite signal, wherein said composite signal is combined with said spurious signal prior to being transmitted so as to suppress said spurious signal to within said spurious requirements for said analog television transmission system;
a local oscillator and a multiplier configured to generate an L.O. signal;
a mixer configured to mix said composite signal output from said modulator and said L.O. signal, said mixer outputting said composite signal at an RF frequency, wherein said modulator is a modulated amplifier; and
an amplifier configured to amplify said composite RF signal before said composite RF signal is combined with said spurious signal.
